(19) United States
(12) Patent Application Publication
(10) Pub. No.: US 2019/0248244 A1
(43) Pub. Date: Aug. 15, 2019

(54) VEHICLE PROPULSION SYSTEM

(71) Applicant: GM GLOBAL TECHNOLOGY OPERATIONS LLC, DETROIT, MI (US)

(72) Inventors: Jack M. Gayney, Grosse Ile, MI (US); Boris Burgman, Oak Park, MI (US)

(21) Appl. No.: 15/896,603

(22) Filed: Feb. 14, 2018

(51) Int. Cl. B60L 11/14; F16H 7/06; F16H 9/26; F16H 48/08; F16H 48/10

(52) U.S. Cl. CPC B60L 11/14; F16H 7/06; F16H 2007/087; F16H 48/08; F16H 48/10; F16H 9/26

(57) ABSTRACT

A vehicle propulsion system includes an electric motor having a hollow rotor shaft, an input drive sprocket connected to the hollow rotor shaft, a first chain mounted on the input drive sprocket, a transfer driven sprocket mounted on a transfer shaft, the first chain is also mounted on the transfer driven sprocket, a transfer drive sprocket mounted on the transfer shaft, a second chain mounted on the transfer drive sprocket, a final drive driven sprocket connected to a differential, the second chain is also mounted on the final drive driven sprocket, a first axle connected to an output of the differential, and a second axle connected to another output of the differential.

### FIELD

The present disclosure relates to a vehicle propulsion system.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Automobile manufacturers are under constant and increasing pressure to improve the efficiency, performance, and fuel economy of their vehicle propulsion systems. This has led to the development of vehicle propulsion systems having alternatives to the internal combustion engine serving as a prime mover in those systems such as, for example, electric motors, fuel cells, and the like. Electric motors in these vehicle propulsion systems typically operate at high speeds with relatively high torque output. This requires a transmission which reduces the speed of the hollow rotor shaft from the electric motor to a speed which is more appropriate for a vehicle final drive. Further, the increased efficient operating speed range of an electric motor, in comparison to an internal combustion engine, reduces and/or eliminates the need to provide a transmission which has the capability to change gear ratios. As a result of these reduced requirements, automotive manufacturers have been able to simplify their propulsion systems and to more compactly position and/or combine the prime mover, transmission, final drive, and axle into a single unit, such as, for example, a transaxle.

An exemplary vehicle propulsion system 100 having a transaxle configuration is illustrated in FIG. 1. The propulsion system 100 includes an electric motor 102 having a hollow rotor shaft 104. The hollow rotor shaft 104 provides motive torque to a first gear set 106 in a transaxle 108. The first gear set 106 includes a first drive gear 110 that is mounted on to rotate with the hollow rotor shaft 104 via splines or the like. The first drive gear 110 has teeth which mesh with corresponding teeth on a first driven gear 112. The first driven gear 112 is mounted on a transfer shaft 114 via splines or the like. The transfer shaft 114, in this exemplary embodiment, integrally incorporates a second drive gear 116 having teeth which mesh with corresponding teeth on a second driven gear 118. The second driven gear 118 is connected to a housing 120 of a differential 122. The differential 122 includes a pin 124 that engages with a set of pinion gears 126 such that torque is transmitted from the housing 120 through the pin 124 and the pinions 126 to a set of axles 128 and 130 that drive wheels (not shown) of the vehicle.

### SUMMARY

In an exemplary aspect, a vehicle propulsion system includes an electric motor having a hollow rotor shaft, an input drive sprocket connected to the hollow rotor shaft, a first chain mounted on the input drive sprocket, a transfer driven sprocket mounted on a transfer shaft, the first chain is also mounted on the transfer driven sprocket, a transfer drive sprocket mounted on the transfer shaft, a second chain mounted on the transfer drive sprocket, a final drive driven sprocket connected to a differential, the second chain is also mounted on the final drive driven sprocket, a first axle connected to an output of the differential, and a second axle connected to another output of the differential

In this manner, the efficiency, fuel economy, emissions, the size, simplicity, noise, vibration, and mass of a vehicle propulsion system may all be improved.

In another exemplary aspect, a ratio between the input drive sprocket and the transfer driven sprocket is greater than two to one.

In another exemplary aspect, the ratio between the transfer drive sprocket and the final drive driven sprocket is greater than two to one.

In another exemplary aspect, the system further includes a transaxle housing.

In another exemplary aspect, the system further includes a bearing mounted to the transaxle housing and rotatably supporting the transfer driven sprocket.

In another exemplary aspect, the bearing is co-planar with the transfer driven sprocket.

In another exemplary aspect, the bearing is a roller-type bearing.

In another exemplary aspect, the system further includes a bearing mounted to the transaxle housing and rotatably supporting the final drive driven sprocket.

In another exemplary aspect, the bearing is co-planar with the final drive driven sprocket.

In another exemplary aspect, the differential is a bevel gear differential.

In another exemplary aspect, the differential is a planetary spur gear differential.

In another exemplary aspect, the width of the second chain is larger than a width of the first chain.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a sectional illustration of a vehicle propulsion system;

FIG. 2 is sectional illustration of a vehicle propulsion system in accordance with the present disclosure; and

FIG. 3 is a sectional illustration of another vehicle propulsion system in accordance with the present disclosure.

In the drawings, reference numbers may be reused to identify similar and/or identical elements.

### DETAILED DESCRIPTION

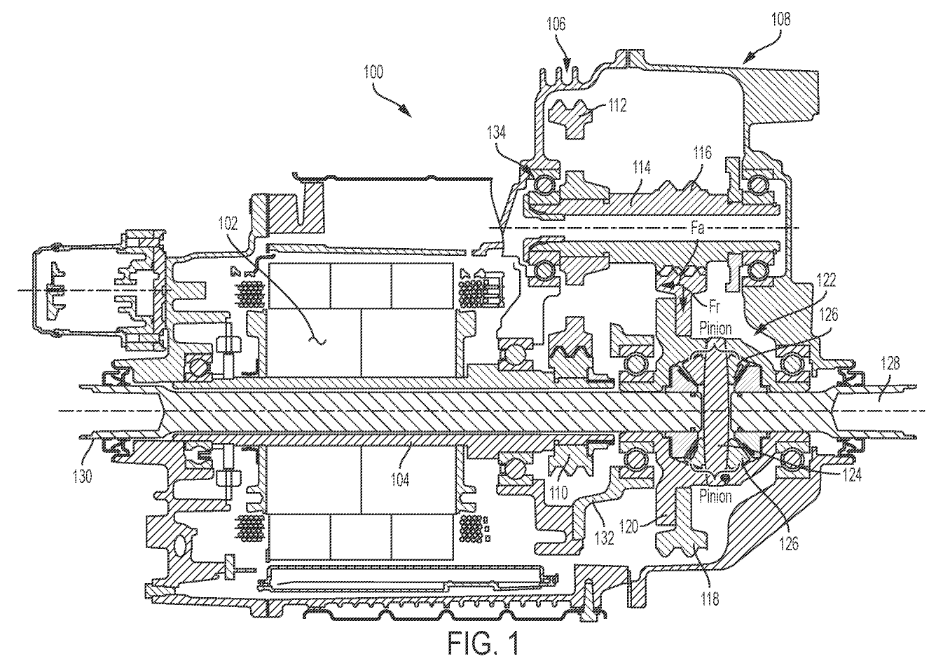

Referring back to FIG. 1, the inventors of the present disclosure realized that the gear sets in the transaxle of the vehicle propulsion system 100 suffer from a number of problems. The meshing of the gear teeth generates an undesirable amount of noise and vibration. These noises and vibrations may be masked when used with a vehicle propulsion system that includes an internal combustion system. However, the noise and vibration may become noticeable in propulsion system which rely upon a much quieter electric motor to generate motive power.

Additionally, the inventors realize that the use of gears in these gear sets results in thrust loads which act in an axial direction. As a result, the use of gears requires bearing sets which provide support not only radially but also axially. These axial loads from the gear sets are known as thrust loads. These thrusts loads increase the demand on the bearing systems to handle not only the radial loads, but also the thrusts loads which reduces the overall efficiency of the system. For example, referring back to the system 100 in FIG. 1, the meshing between the second drive gear 116 and the second driven gear 118 result in a force having a radial component Fr and an axial component Fa. In order to accommodate for the axial component of the force Fa, a center support 132 (incorporating a plurality of bolts and dowels, not shown) is required. The inventors of the present disclosure solved these problems while also enabling additional advantages over conventional designs.

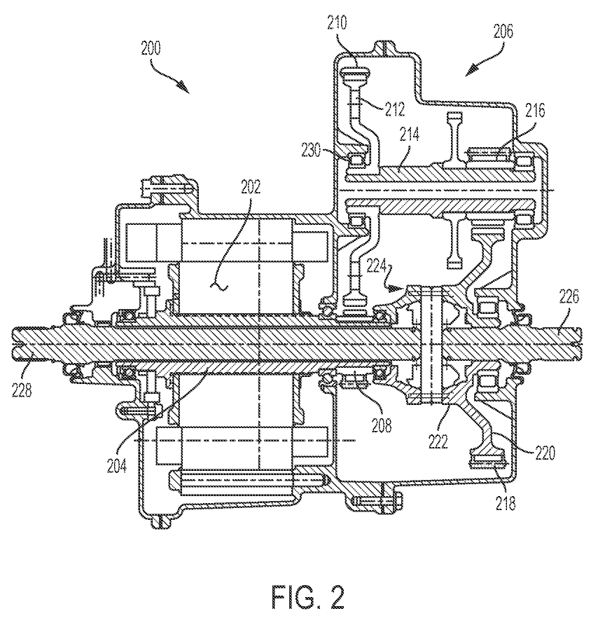

FIG. 2 illustrates an exemplary vehicle propulsion system 200 having a transaxle configuration in accordance with the present disclosure. The system 200 includes an electric motor 202 having a hollow rotor shaft 204 for providing motive torque to a transaxle 206. The system 200 includes a input drive sprocket 208 that is mounted on the hollow rotor shaft 204 via a splined connection or the like. A first chain 210 is mounted on the input drive sprocket 208 and also on a transfer driven sprocket 212. The transfer driven sprocket 212 is mounted on a transfer shaft 214 such that the transfer shaft 214 rotates with the transfer driven sprocket 212. A transfer drive sprocket 216 is also mounted on the transfer shaft 214 such that it rotates with the transfer shaft 214 via a splined connection or the like. A second chain 218 is mounted on the transfer drive sprocket 216 and also on a final drive driven sprocket 220. The transfer drive sprocket 220 is integrated into a housing 222 of a bevel gear differential 224. The differential 224 distributes the torque received from the transfer drive sprocket 220 to a set of axles 226 and 228 that drive wheels (not shown) of the vehicle incorporating the vehicle propulsion system 200.

The inventive exemplary embodiment of the vehicle propulsion system 200 of FIG. 2 has a number of advantages in comparison to the vehicle propulsion system 100 of FIG. 1. Firstly, the chain drive systems in the inventive embodiments operate with much less noise and vibration. As explained above, this is especially advantageous when the vehicle propulsion system relies upon an electric motor to generate motive torque rather than an internal combustion engine which would generate sufficient noise and vibration that would mask the noise and vibration generated by gear sets. In the absence of the masking noise and vibration, the advantage of a chain/sprocket drive which is much quieter becomes much more important.

Further, the ability to rely upon a chain/sprocket drive system rather than a gear set provides an improvement in efficiency which is increasingly important to improve fuel economy, reduce emissions and the like.

In stark contrast to the gear sets of the system 100, the chain/sprocket sets of the system 200 do not generate axial thrust loads. Therefore, the bearing sets of the system 200 do not need to handle axial thrust loads. As a result of this reduced requirement, the system 200 may incorporate roller type bearings rather than ball bearings. The ability to incorporate roller type bearings enables a more compact design and packaging. In general, roller type bearings are smaller than a comparable ball type bearing. Further, in accordance with the present disclosure use of roller type bearings, and the eliminated requirement to handle thrust loads, the bearings may be positioned to be co-planar to the chain/sprocket sets. In this manner, overall transaxle size may be much more compact than traditional transaxle designs.

Moreover, with the substantial reduction and/or elimination of thrust loads from the chain/sprocket sets, in comparison to gear sets, the size of those bearings which may continue be required to handle axial loads, such as a positioning load may also be reduced in size as positioning loads are generally much lower than thrust loads from a gear set.

Additionally, the ability to position the bearings co-planar with the chain/sprocket sets reduces and/or eliminates the requirement for the shaft carrying and/or transferring the load from any chain/sprocket set to a bearing. In this manner, the load requirement for the shaft is reduced which may further enable a reduction in the mass of the shaft. For example, referring to FIG. 1 note that the first driven gear 112 is not co-planar with the closest adjacent bearing 134. Therefore, the radial force applied by the first driven gear 112 to the transfer shaft 114 is cantilevered from the bearing 134. Thus, the transfer shaft 114 must be designed to handle this cantilevered load. Further, the meshing between the second drive gear 116 and the second driven gear 118 result in a force having a radial component Fr and an axial component Fa. In order to accommodate for the axial component of the force Fa, a center support 132 (incorporating a plurality of bolts and dowels, not shown) is required. In stark contrast, referring now to FIG. 2, the first driven sprocket 212 is co-planar to the bearing 230. Therefore, the transfer shaft 214 is not required to be designed to accommodate any cantilevered forces. Further, the ability to position the bearings co-planar with the chain/sprocket also enables the overall structure to be simplified, for example, no center support is required.

In the exemplary embodiment of FIG. 2, the ratios of the sprockets are relatively large in order to provide the necessary speed reduction and torque increase through the transaxle. For example, sprocket ratios for the present disclosure may exceed a ratio of two to one which is also uniquely advantageous to the present disclosure. In stark contrast, previous applications of chain/sprocket sets have been limited to not much greater than a one to one ratio. Those applications have primarily been designed merely to transfer power between two different axes. In contrast, the present disclosure also enables a significant reduction in speed and increase in torque due to the higher ratios. The torque increase through the transaxle may be accommodated by providing a second chain 218 of the system 200 in FIG. 2 that is larger than the first chain 210 because the torque carried by the second chain 218 is larger than that carried by the first chain 210 as a result of the increase in ratio over previous chain/sprocket applications.

It should be further noted, that the higher torque capacity of the exemplary embodiments of the present disclosure is further enabled by the combination of the chain/sprocket set and the use of a compact roller bearing that are arranged co-planar with each other. Further, the roller bearings of the exemplary embodiments may be supported directly by a housing of the transaxle, rather than by a shaft as has previously been done with conventional gear set transaxles designs. The shafts of those conventional gear set designs have had to be beefed up to support the forces and transfer those forces to the housing which requires an increase in the mass and size of those supporting shafts(s). In contrast, the co-planar bearings enable the housing to directly carry the radial load.

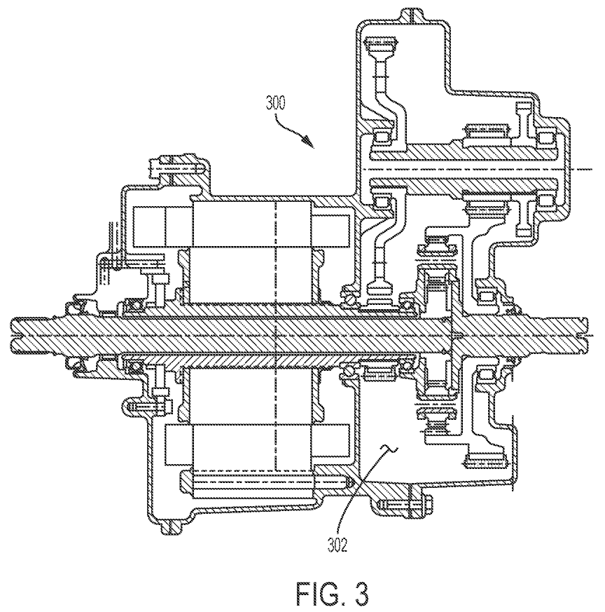

Referring now to FIG. 3, another exemplary embodiment of a vehicle propulsion system 300 in accordance with the present disclosure is illustrated. One difference between the system 200 of FIG. 2 and the system 300 of FIG. 3 is the incorporation of a planetary spur gear differential 302 rather than a bevel gear differential 224. The inventive use of chain/sprocket sets and the accompanying ability to use co-planar bearings to support those chain/sprocket sets, enables the use of a much more compact planetary spur gear differential 302, in comparison to a bevel gear differential 224 of other transaxle designs. Other transaxle system which have relied upon gear sets that have required a differential having the ability to handle the thrust loads that are generated by the gear sets. For example, referring again back to FIG. 1, the second driven gear 118 generates a thrust load (i.e. force Fa) which is transferred to and must be carried by the differential housing 120. Therefore, the differential 122 is required to have the ability to handle those thrust loads. In stark contrast, because of the inventive use of chain/sprocket sets of exemplary embodiments of the present disclosure, the differential does not need to handle any thrust loads. This enables the use of a planetary spur gear differential, such as that illustrated at 302 in FIG. 3, which, in turn, has a reduced axial extent and further enables a more compact overall design for the transaxle system 300.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A vehicle propulsion system, the system comprising:
an electric motor having a hollow rotor shaft;
an input drive sprocket connected to the hollow rotor shaft;
a first chain mounted on the input drive sprocket;
a transfer driven sprocket mounted on a transfer shaft and wherein the first chain is also mounted on the transfer driven sprocket;
a transfer drive sprocket mounted on the transfer shaft;
a second chain mounted on the transfer drive sprocket;
a final drive driven sprocket connected to a differential and wherein the second chain is also mounted on the final drive driven sprocket;
a first axle connected to an output of the differential; and
a second axle connected to another output of the differential.

2. The system of claim 1, wherein a ratio between the input drive sprocket and the transfer driven sprocket is greater than two to one.

3. The system of claim 1, wherein the ratio between the transfer drive sprocket and the final drive driven sprocket is greater than two to one.

4. The system of claim 1, further comprising a transaxle housing.

5. The system of claim 4, further comprising a bearing mounted to the transaxle housing and rotatably supporting the transfer driven sprocket.

6. The system of claim 5, wherein the bearing is co-planar with the transfer driven sprocket.

7. The system of claim 5, wherein the bearing comprises a roller-type bearing.

8. The system of claim 4, further comprising a bearing mounted to the transaxle housing and rotatably supporting the final drive driven sprocket.

9. The system of claim 8, wherein the bearing is co-planar with the final drive driven sprocket.

10. The system of claim 5, wherein the bearing comprises a roller-type bearing.

11. The system of claim 1, wherein the differential comprises a bevel gear differential.

12. The system of claim 1, wherein the differential comprises a planetary spur gear differential.

13. The system of claim 1, wherein a width of the second chain is larger than a width of the first chain.

14. A vehicle comprising,
an electric motor having a hollow rotor shaft;
an input drive sprocket connected to the hollow rotor shaft;
a first chain mounted on the input drive sprocket;
a transfer driven sprocket mounted on a transfer shaft and wherein the first chain is also mounted on the transfer driven sprocket;
a transfer drive sprocket mounted on the transfer shaft;
a second chain mounted on the transfer drive sprocket;
a final drive driven sprocket connected to a differential and wherein the second chain is also mounted on the final drive driven sprocket;
a first axle connected to an output of the differential;
a second axle connected to another output of the differential;
a first driven wheel connected to the first axle; and
a second driven wheel connected to the second axle.

15. The system of claim 14, wherein a ratio between one of the input drive sprocket and the transfer driven sprocket and the transfer drive sprocket and the final drive driven sprocket is greater than two to one.

16. The system of claim 14, further comprising:
a transaxle housing;
a first roller-type bearing mounted to the transaxle housing and rotatably supporting the transfer driven sprocket, and wherein the first roller-type bearing is co-planar with the transfer driven sprocket; and
a second roller-type bearing mounted to the transaxle housing and rotatably supporting the final drive driven sprocket, and wherein the second roller-type bearing is co-planar with the final drive driven sprocket.

17. The system of claim 14, wherein the differential comprises a bevel gear differential.

18. The system of claim 14, wherein the differential comprises a planetary spur gear differential.

19. The system of claim 14, wherein a width of the second chain is larger than a width of the first chain.
